(19) United States
(12) Patent Application Publication
(10) Pub. No.: US 2008/0273130 A1
(43) Pub. Date: Nov. 6, 2008

(54) DISPLAY DEVICE

(75) Inventors: Hsiu-Chi Tung, Hsinchu (TW); Ching-Yu Tsai, Hsinchu (TW); Chih-Ming Chang, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/954,265

(22) Filed: Dec. 12, 2007

(30) Foreign Application Priority Data
May 1, 2007 (TW) 96115458

(51) Int. Cl. G02F 1/1335; G02F 1/1333

(52) U.S. Cl. 349/38; 349/114

(57) ABSTRACT

A display comprises a driving circuit region and a pixel region electrically connected to the driving circuit region. The pixel region includes a micro-reflective pixel structure with a reflective electrode, a transparent pixel structure with a transparent electrode, and a dielectric layer formed on the reflective electrode, so that the transparent electrode, formed on the dielectric layer, electrically connects to the reflective electrode.

### BACKGROUND OF THE INVENTION

1. Field of the Invention

The present invention relates to a display device and, more particularly, to a transflective display device.

2. Description of the Related Art

Conventionally, a transflective liquid crystal display (LCD) employs light emitted both from surrounding and back light formed in the LCD to display image. The transflective liquid crystal display has the advantages of lower power consumption than the transparent liquid crystal display.

FIG. 1 is a cross-section of a conventional transflective LCD panel. The conventional transflective LCD panel includes the assembly of rear substrates 10 and front substrates 12, respectively made of transparent materials. Display image is viewed from one side of the front substrate 12 while the backlight (not shown) is placed on one side of the rear substrate 10. A liquid crystal layer 14 is sandwiched between the rear substrate 10 and the front substrate 12 to modulate light value and thereby achieve image display. In general, the liquid crystal layer 14 is a twist nematic mode (TN mode) liquid crystal with a twist angle of 90°.

The conventional transflective LCD panel within a pixel electrode structure conventionally includes a reflective electrode 16 placed adjacent to a transmissive electrode 18. Both reflective, transmissive electrodes 16 18 thereby respectively define a reflective area 20 and a transmissive area 22. The reflective electrode 16 is composed of a reflective plate made of a metallic material having suitable reflectance, while the transmissive electrode 18 is conventionally made of a transparent conductive material such as indium-tin-oxide or indium-zinc-oxide.

In the transmissive area, light 24 coming from the backlight (not shown) travels through the transmissive electrode 18, and transmits via the liquid crystal layer 14 to show at the viewed side for displaying images. In the reflective area, light 26 comes from an external light source on the viewed side (not shown), travels through the liquid crystal 14, reflects on the reflective electrode 16, and travels again through the liquid crystal 14 to show at the viewed side. The conventional transflective LCD panel, however, has poor reflection ability and usually requires switch on the backlight when the external light source in the environment is weak.

In order to solve the above problem, a conventional transflective LCD panel with micro-reflective mode is disclosed and including a dual brightness enhancement film (DBEF) formed on the viewed side of the front substrate 12 of the conventional transflective LCD panel, but a parallax problem is caused during reflection mode. In general, the conventional transflective LCD panel with micro-reflective mode used the liquid crystal layer is similar as the conventional transflective LCD panel without micro-reflective mode, and the liquid crystal layer 14 is a twist nematic mode (TN mode) liquid crystal with a twist angle of 90°. Therefore, besides an inherent polarizer, an inside polarizer is further employed to solve the problem which liquid crystal molecules unevenly distribute in the brightness state and dark state. However, the above way would not achieve preferable liquid crystal molecules distribution in the brightness state and dark state.

The influence of one factor on the performance quality of the conventional transflective LCD is optical efficiency. The optical response depends upon the phase retardation of the liquid crystal unit, characterized by the represent “dΔn”, wherein d is the cell gap (referring to FIG. 1) and “Δn” is the average birefringence of the liquid crystal within the cell gap. In the transmissive area, the optical retardation conventionally is optimal for dΔn˜(½)λ, while in the reflective area is optimal for dΔn˜(¼)λ. One technical issue encountered for conventional transflective LCDs is that the same phase retardation occurs in both the reflective area and transmissive area. Currently, there is not any method to obtain improved optical characteristics in both the reflective and transmissive areas of a conventional transflective LCD.

Therefore, there is presently a need for a transflective LCD that has improved optical characteristics in both the reflective and transmissive areas.

### BRIEF SUMMARY OF THE INVENTION

An exemplary embodiment a pixel structure comprises: a first substrate; a plurality of single lines formed on the first substrate to define a plurality of pixels; at least one switch element is formed on each pixel; at least one storage capacitor is formed in each pixels, connecting the switch element; a dielectric layer covering the first substrate; a pixel electrode formed on the dielectric layer, electrically connected to at least one of the switch elements and the storage capacitors, wherein at least one of the single lines, the switch elements, and the storage capacitors is an electrode act as a micro-reflective region.

According to another embodiment of the present invention, a display device comprises: a driving circuit region; and a pixel structure, wherein the pixel structure comprises a first substrate, a plurality of single lines formed on the first substrate to define a plurality of pixels, at least one switch element is formed on each pixel, at least one storage capacitor is formed in each pixels, connecting the switch element, a dielectric layer covering the first substrate, a pixel electrode formed on the dielectric layer and electrically connected to at least one of the switch elements and the storage capacitors, wherein at least one of the single lines, the switch elements, and the storage capacitor is an electrode act as micro-reflective regions.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-section of a conventional liquid crystal display device.

FIG. 2 is a partial schematic top view of a liquid crystal display device according to an embodiment of the present invention.

FIGS. 3a˜3c are cross-sections along line I-I′ of FIG. 2.

FIGS. 4a˜4c are schematic top views of FIG. 3a˜3c according to an embodiment of the present invention.

FIG. 5 is a graph plotting voltage and transparency of transmission area of the liquid crystal display device as disclosed in an embodiment of the present invention.

FIG. 6 is a graph plotting voltage and reflectivity of reflective region of the liquid crystal display device as disclosed in an embodiment of the present invention.

FIG. 7 schematically shows another embodiment of an electro-optical device for displaying images.

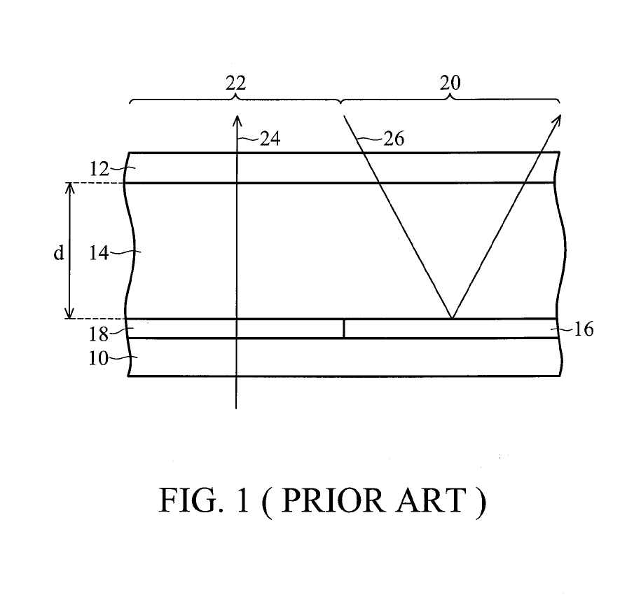

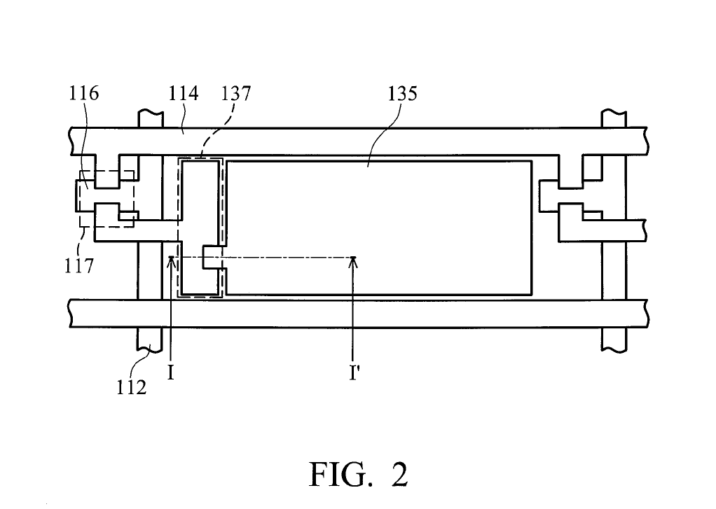

### DETAILED DESCRIPTION OF THE INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

FIG. 2 is a top view of an embodiment of a pixel structure of a LCD with micro-reflective structure. The LCD comprises a plurality of pixel structures arranged in a matrix form. Each pixel structure comprises a gate line 112, a data line 114 is substantially interlaced with the gate line 112, a storage capacitor 137, and a switching element 117 electrically connected to the gate line 112, the storage capacitor 137, and the data line 114.

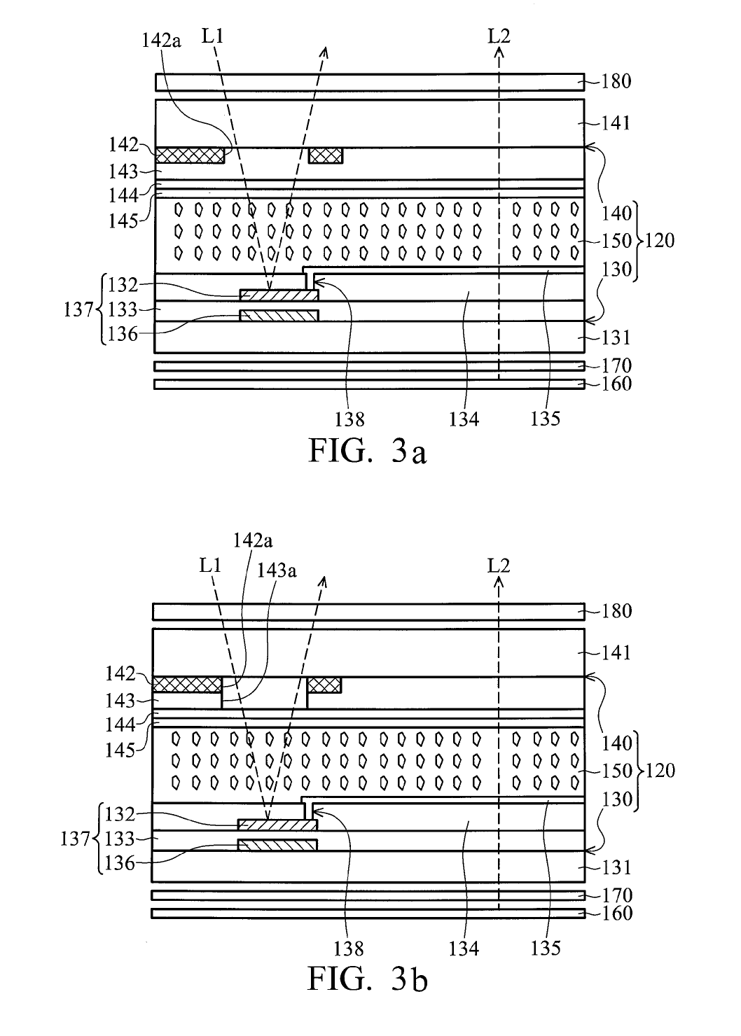

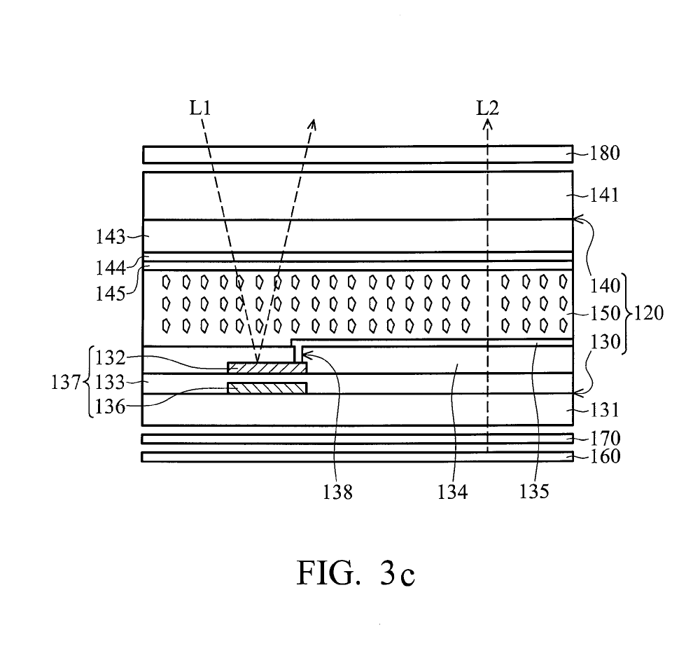

In the present invention, the switching element 117 can be a thin film transistor (TFT), such as bottom gate TFT (such as back channel etched-TFT, etched stopped-TFT, or others), top gate TFT (such as LTPS-TFT or others), or combinations thereof. The thin film transistor, comprises a gate electrode 116, a source/drain electrode (not shown), and active layer (not shown) is located between the gate electrode 116 and the source/drain electrode, wherein the gate electrode 116 is electrically connected to the gate line 112 and the source/drain electrode is electrically connected to the data line 114. Suitable material of the active layer can comprise silicon-containing single crystal material, silicon-containing polycrystalline material, silicon-containing noncrystalline material, silicon-containing, microcrystalline material, or combinations thereof. Each pixel structure also comprises a pixel electrode 135 electrically connected to the storage capacitor 137. FIGS. 3a to 3c are cross-sectional views along line I-I′ of FIG. 2 illustrating the pixel structure of a LCD according to a preferred embodiment of the present invention.

According to an embodiment of the present invention, the micro-reflective region is disposed on a capacitor 137. In another embodiment, the micro-reflective region can be disposed on at least one of the switch element (such as a TFT), capacitor 137, and single lines (data line 114 and gate line 112). The openings, corresponding to the micro-reflective region and introducing ambient light, can be disposed within the color filter, black matrix, or combinations thereof. In this embodiment, the storage capacitor 137 acts as micro-reflective region and can provide a voltage dividing manners, so as to obtain the preferred optical characteristics in both the reflective area and transmissive area.

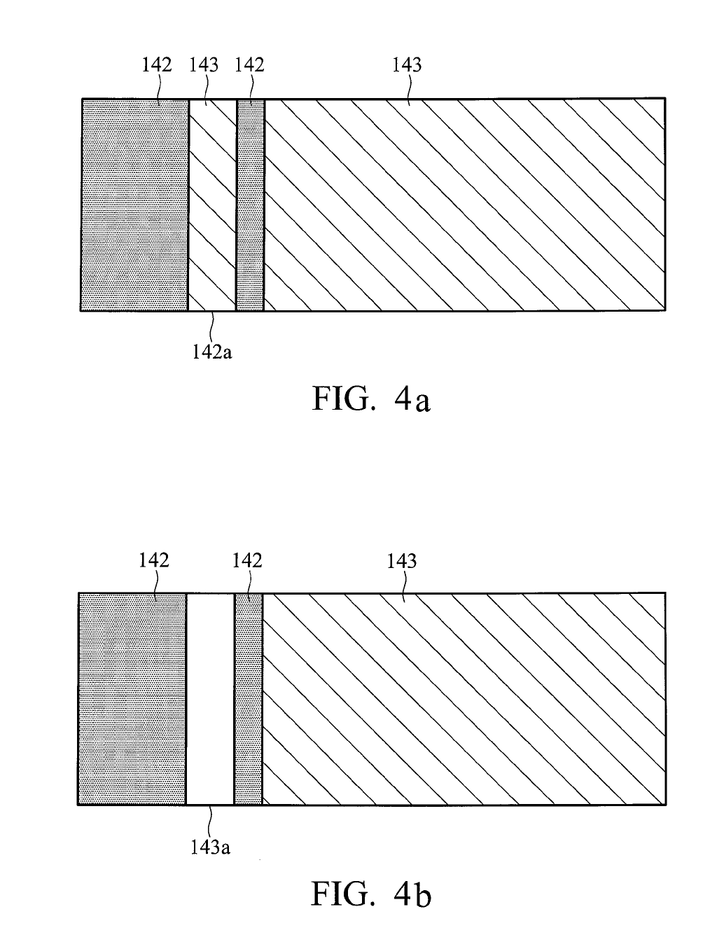

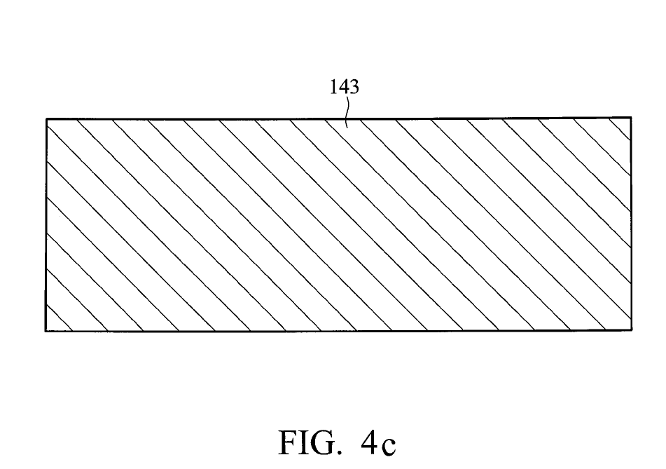

The liquid crystal display device 100 comprises a liquid crystal display panel 120, a backlight module 160, a first polarizer 170, and a second polarizer 180. The liquid crystal display panel 120 comprises a rear substrate 130, a front substrate 140, and a liquid crystal layer 150. The rear substrate 130 comprises a first substrate 131, a storage capacitor 137, an insulating layer 133, a pixel electrode 135, and a dielectric layer 134. The storage capacitor 137 is disposed on the first substrate 131 and comprises a storage capacitor electrode 132 or namely upper electrode, the insulating layer 133, and part of the gate line 136 or namely lower electrode. The dielectric layer 134, with contact hole 138, is disposed on the insulating layer 133 to cover part of the storage capacitor electrode 132. The pixel electrode 135 is disposed on part of the dielectric layer 134 and electrically connects to the storage capacitor electrode 132 via the contact hole 138. A front substrate 140 substantially parallel with the rear substrate 130 comprises a second substrate 141, a black matrix 142, and a common electrode 144. The black matrix 142 disposed on the second substrate 141 has an opening 142a corresponding to a storage capacitor 137. FIG. 4a is a top-view illustrating the location relationship between the black matrix 142 and the opening 142a. The black matrix 142 comprises a non-transparent layer. A color filter layer 143 is exposed outside of the black matrix 142. The opening 142a disposed over the storage capacitor 137 corresponds to the storage capacitor electrode 132 and adjacent to a place which the storage capacitor electrode 132 connected to the pixel electrode 135. The incident light L1 is introduced into the liquid crystal display panel 120 via the opening 142a, and reflected by the storage capacitor electrode 132 so as to act one of a light source. The common electrode 144 is disposed on the second substrate 141 over the black matrix 142 and the opening 142a. The crystal liquid layer 150 disposed between the rear substrate 130 and the front substrate 140. The backlight module 160 is disposed under the liquid crystal display panel 120 and adjacent to the first substrate 131, thereby providing a light L2 for the liquid crystal display panel 120 pass through the pixel electrode 135, liquid crystal layer 150, and front substrate 140 to the environment. The first polarizer 170 is disposed between the backlight module 160 and the liquid crystal display panel 120. The second polarizer 180 is disposed on the liquid crystal display panel 120 and adjacent to the second substrate 141 of the front substrate 140. The contact hole 138 can be disposed within the projection region of the opening 142a. In another embodiment, a portion of the contact hole 138 can be disposed within the projection region of the opening 142a. Further, the contact hole 138 can be disposed outside the projection region of the opening 142a. The backlight module can comprise point source (such as organic light emitting diode, or inorganic light emitting diode, or others, or combinations thereof), lamp (such as cold cathode fluorescent lamp, plane lamp, hot cathode fluorescent lamp, external electrode fluorescent lamp, or others), electroluminescent light source, surface contact light source (such as carbon nanotube light source, or others), or others, or combinations thereof.

The liquid crystal display panel 120, preferred, can further comprise an alignment layer 145 (such as a vertical alignment layer or others) disposed on the common electrode 144. The front substrate 141 further comprises a color filter layer 143. The color filter layer 143 is disposed between the second substrate 141 and the common electrode 144 covering the black matrix 142 and opening 142a, as shown in FIG. 3a.

FIG. 4a is a top-view illustrating the location relationship between the black matrix 142 and the opening 142a.

Further, the color filter layer 143 can comprise an opening 143a, referring to FIG. 3b. FIG. 4b is a top-view illustrating the location relationship between the black matrix 142, color filter layer 143, and the opening 143. Moreover, the storage capacitor 137 can be disposed outside the projection region of the opening 142a of the black matrix 142, as shown in FIG. 3c and FIG. 4c is the top-view of the FIG. 3c.

According to another embodiment of the present invention, the color filter layer 143 can be formed on the second substrate 141, on the dielectric layer 134, or between the first substrate 131 and the dielectric layer 134, besides being formed on the first substrate 131 and the second substrate 141.

The storage capacitor electrode 132 comprises Al, Au, Ag, Cr, Mo, Nb, Ti, Ta, W, Nb, alloy thereof, or others, or combinations thereof. At least one of the insulating layer 133 and the dielectric layer 134 can be inorganic material (such as silicon oxide, silicon nitride, oxynitrid, silicon carbide, hafnium oxide, or others, or combinations thereof), organic material (such as photoresist, polyarylene ether, polyester, polyamide, polyidmide, polyglycol, polyolefine, benzocyclclobutene, hydrogen silsesquioxane, methyl silesquioxane, SiOC—H, or others, or combinations thereof), or combinations thereof. It should be noted that the reflective electrode, preferred, is act as a portion of the storage capacitor. In order to provide an optical retardation value is substantially equal to ¼, preferred, a dielectric layer 134 require has a specific thickness and a specific dielectric constant is formed over the storage capacitor electrode 132 to adjust the electrical filed of the crystal liquid layer 150.

Herein, the dielectric layer 134 (for example organic material) has a dielectric constant is substantially less than or substantially equal to 3.5 and a thickness ranges from about 1.7 μm to about 2 μm. Certainly, the dielectric layer 134 according to embodiment of the present invention can be altered as specific, at least one of the material (such as organic material, inorganic material, or combinations thereof), thickness (less than 2 μm, more than 2 μm, equal to 2 μm, or other thickness), and the dielectric constant (less than 3.5, more than 3.5, or others). The first polarizer 170 and second polarizer 180 are substantially parallel as the example. The optical retardation between the transmissive area and the reflective area has a difference value is modified to (½)λ at about zero driving voltage, thereby blocking the light passing through the crystal liquid layer 150. To the contrary, the alignment direction of liquid crystal molecules in the transmissive area is substantially parallel with the electric field direction during applying a driving voltage, resulting in the optical retardation between the transmissive area and the reflective area has a difference value is modified to about zero.

In an embodiment of the present invention, for example, about zero volt voltage is provided to the common electrode 144 and four volt voltage is provided to the pixel electrode 135 and storage capacitor electrode 132 via data lines. Since the pixel electrode 135 does not separate from the crystal liquid layer 150 by the dielectric layer 134, the potential difference between the pixel electrode 135 (transmissive area) and the crystal liquid layer 150 is about 4 volt. Further, the potential difference between the storage capacitor electrode 132 (such as reflective electrode) and the crystal liquid layer 150 is reduced to about 2 volt via a voltage dividing manner (such as coupling capacitance, multi-com, or others), since the dielectric layer 134 is formed between the storage capacitor electrode 132 and the crystal liquid layer 150 in the reflective area resulting in the barrier effect. So, the potential difference in the micro-reflective region is substantially equal to the half of potential difference in the transmissive region, and therefore to form the optical retardation is about (¼)λ. In other words, due to the barrier effect, the voltage of the micro-reflective area is substantially less than or substantially equal to that of the transmissive area. Therefore, the obtained liquid crystal display device can exhibit high contrast and maintain the same cell gaps both in the reflective area and the transmissive area. The operating voltage disclosed above is an example of the present invention, and the operating voltage can be altered for liquid crystal display as necessary.

Accordingly, due to the patterned dielectric layer 134, voltage dividing manners of the liquid crystal display device are provided and the reflective area and transmissive area have substantially different electric field intensity.

In embodiments of the present invention, since the electric field intensity of the reflective area is substantially less than that of the transmissive area, the birefringence Δn in transmissive area and reflective area is modified and the phase retardation of the liquid crystal unit dΔn is controable, thereby optimizing the optical retardation and efficiency in transmissive area and reflective area. During operation, the liquid crystal display is driven according to an inversion mode, i.e. each pixel at two successive display frames is supplied with an image signal of inverted voltage bias. To obtain good and stable boundary regions distinguishing different directions of inclination of the liquid crystal molecules, the present application envisions different configurations of the pixel electrode structure as detailed hereafter.

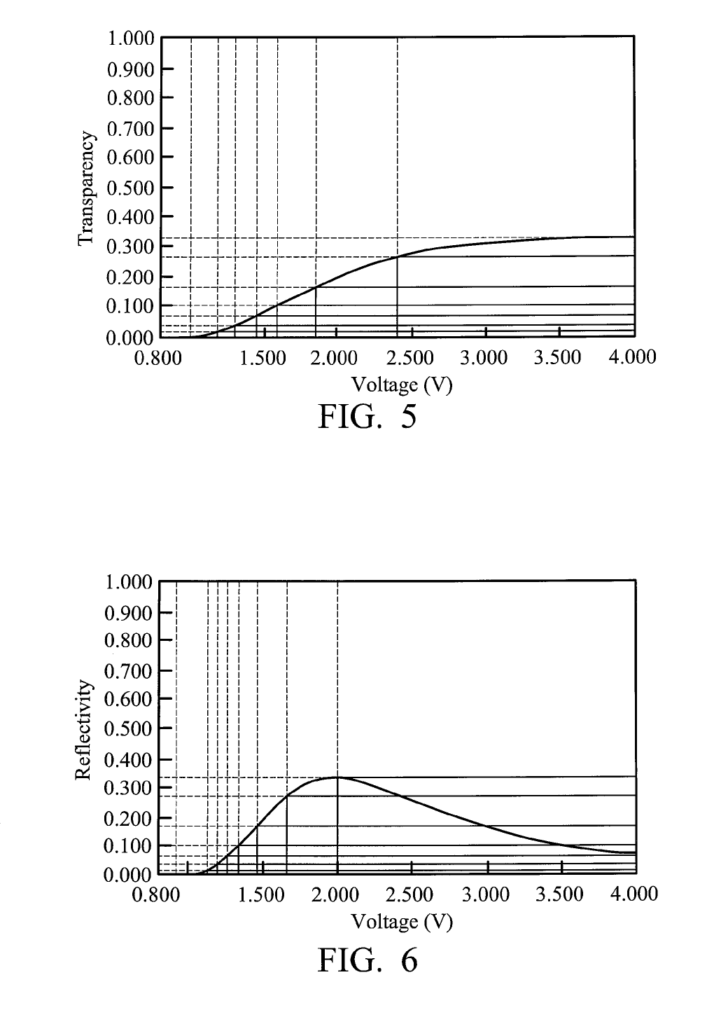

FIG. 5 is a graph plotting voltage and transparency of transmission area of the liquid crystal display device as disclosed in an embodiment of the present invention. The transmissive area of the liquid crystal display device has a transparency of about 0.33 at about 4 volt voltage and an optical retardation of (½)λ at bright state. Further, FIG. 6 is a graph plotting voltage and reflectivity of reflective region of the liquid crystal display device as disclosed in the same embodiment of FIG. 5. The reflective area of the liquid crystal display device has a reflectivity of about 0.33 at about 2 volt voltage and an optical retardation of (¼)λ at bright state.

The liquid crystal display device of the present invention can be a vertical alignment liquid crystal display device with micro-reflective areas, but not limited it. Further, the liquid crystal display device has a reflective area corresponding to the storage capacitor and a transmissive area corresponding to the pixel electrode as an example. When applying a driving voltage to the pixel electrode, due to the barrier effect of the dielectric layer, the voltage-reflective (V-R) curve of the reflective area is adapted to match the voltage-transparency (V-T) curve of the transmissive area, thereby enhancing the contrast of the liquid crystal display device.

In conventional liquid crystal display devices, an inner polarizer was employed to serve as inner reflective layer to modify the strength of light L1. To the contrary, due to the voltage dividing manners, the embodiment of the present invention can modify the strength of light L1 without the inner polarizer. Preferably, the liquid crystal of the present invention can have a twist angle of about 0°, such as electrically controlled birefringence mode liquid crystal. Due to the dielectric layer with a specific thickness formed on the electric capacitor, the reflective area and the transmissive area have the saturation voltage are substantially identical and threshold voltage in the different area is substantially identical via voltage dividing manners.

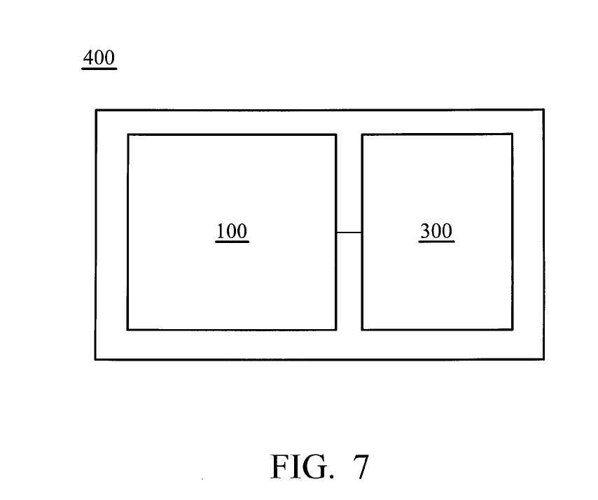

FIG. 7 schematically shows another embodiment of an electro-optical device 400. The electro-optical device 400 comprises the liquid crystal display device 100 electrically connected to an electrical device 300. The electrical device 300 comprises a control element, operation element, driving element, emitting element, protecting element, input element, memory element, sensor, detector, or other device with other function, or combinations thereof.

The electro-optical device 400 can be includes portable products (e.g. mobile phones, camcorders, cameras, notebook computers, digital photo frames, game players, watches, music players, e-mail receivers and senders, map navigators, or the like), audio-video products (e.g. audio-video players or the like), screens, televisions, indoor/outdoor bulletin boards, panels in projectors, and so on.

At least one of the color filter layers and the black matrix can be disposed on the second substrate. For example, the color filter layer is disposed on the rear substrate, and the black matrix is disposed on the front substrate. Further, at least one of the color filter layer and the black matrix can dispose on at least one of the first substrate and the second substrate. For example, the color filter layer disposes on the first substrate and the black matrix disposes on the second substrate, the color filter layer disposes on the second substrate and the black matrix disposes on the first substrate, the color filter layer and the black matrix both dispose on the second substrate, or others. In the embodiment, the black matrix can be metal (such as Al, Au, Ag, Cr, Mo, Nb, Ti, Ta, W, Nb, oxide thereof, nitride thereof, alloy thereof, or others, or combinations thereof), organic compound (such as black resin, at least two color resin overlapped, or others, or combinations thereof), or inorganic material (such as silicon oxide, silicon nitride, silicon oxynitride, hafnium oxide, silicon carbide, or others, or combinations thereof), or combinations thereof. Further, the above-mention embodiments of the pixel electrode of the present can be comprise transparent material (such as indium tin oxide (ITO), indium zinc oxide (IZO), aluminum zinc oxide (AZO), aluminum tin oxide (ATO), cadmium tin oxide (CTO), cadmium zinc oxide (CZO), indium tin zinc oxide (ITZO), hafnium oxide, zinc oxide, or others, or combinations thereof) as an example, but not limited it. In another embodiments, one portion of the pixel electrode comprises transparent material (such as indium tin oxide (ITO), indium zinc oxide (IZO), aluminum zinc oxide (AZO), aluminum tin oxide (ATO), cadmium tin oxide (CTO), cadmium zinc oxide (CZO), indium tin zinc oxide (ITZO), hafnium oxide, zinc oxide, or others, or combinations thereof), and another portion of the pixel electrode comprises reflective material (such as golden, silver, copper, iron, tin, zinc, cadmium, aluminum, molybdenum, tungsten, neodymium, titanium, tantalum, hafnium, oxide thereof, nitride thereof, alloy thereof, or others, or combinations thereof). The above-mentioned embodiment of the storage capacitor 137 of the present invention is used the capacitor on gate line (Cs on gate) as an example, but not limited it, in another embodiment, the capacitor can be a capacitor on common line (Cs on common) or both with Cs on gate and Cs on common.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel structure, comprising:
a first substrate;
a plurality of single lines formed on the first substrate to define a plurality of pixels;
at least one switch element formed on each pixel;
at least one storage capacitor, formed in each pixel, and connected to the switch element;
a dielectric layer covering the first substrate;
a pixel electrode formed on the dielectric layer and electrically connected to at least one of the switch elements and the storage capacitors, wherein at least one of the single lines, the switch elements, and the storage capacitors is an electrode act as micro-reflective regions.

2. The pixel structure of claim 1, wherein the pixel electrode comprises a transparent material, or combinations of a reflective material and the transparent material.

3. The pixel structure of claim 1, further comprising:
a second substrate opposite to the first substrate, and the second substrate comprises a common electrode; and
a crystal liquid layer disposed between the first substrate and the second substrate.

4. The pixel structure of claim 3, further comprising a black matrix, formed on the second substrate, and with at least one opening substantially corresponding to at least one of the micro-reflective regions.

5. The pixel structure of claim 4, further comprising a color photoresist layer disposed one of between the first substrate and the second substrate, on the second substrate, and between the first substrate and the dielectric layer.

6. The pixel structure of claim 1, wherein the dielectric layer has a dielectric constant is substantially less than or substantially equal to 3.5.

7. The pixel structure of claim 1, wherein the thickness of the dielectric layer ranges from about 1.7 μm to about 2 μm.

8. The pixel structure of claim 1, wherein the micro-reflective regions comprises a reflective electrode is act as a part of the storage capacitor.

9. The pixel structure of claim 8, further comprising:
a black matrix, disposed on a second substrate corresponding to the storage capacitor, and with an opening, wherein the opening, corresponding to the reflective electrode, and introduces an ambient light.

10. The pixel structure of claim 9, further comprising: a color photoresist layer disposed on one of the first substrate and the second substrate.

11. A display device, comprising:
a driving circuit region; and
a pixel structure of claim 1 electrically connected to the driving circuit region.

12. The display device of claim 11, wherein the pixel electrode comprises a transparent material, or combinations of a reflective material and the transparent material.

13. The display device of claim 11, further comprising:
a second substrate opposite to the first substrate, and the second substrate comprises a common electrode; and
a crystal liquid layer disposed between the first substrate and the second substrate.

14. The display device of claim 13, further comprising a black matrix, formed on the second substrate, and with at least one opening corresponding to at least one of the micro-reflective regions.

15. The display device of claim 14, further comprising a color photoresist layer disposed one of between the first substrate and the second substrate, on the substrate, and between the first substrate and the dielectric layer.

16. The display device of claim 13, wherein the dielectric layer has a dielectric constant is substantially less than or substantially equal to 3.5.

17. The display device of claim 13, wherein a thickness of the dielectric layer ranges from about 1.7 μm to about 2 μm.

18. The display device of claim 13, wherein the micro-reflective regions comprises a reflective electrode is act as a part of the storage capacitor.

19. The display device of claim 18, further comprising:
a black matrix, disposed on a second substrate corresponding to the storage capacitor, and with an opening, wherein the opening, corresponding to the reflective electrode, and introduces an ambient light.

20. The display device of claim 19, further comprising a color photoresist layer disposed on one of the first substrate and the second substrate.
